(19) United States
(12) Patent Application Publication
(10) Pub. No.: US 2009/0057376 A1
(43) Pub. Date: Mar. 5, 2009

(54) Automated evacuation and sealing process

(75) Inventors: William S. Hoover, Plain City, OH (US); Josh M. Fribley, Columbus, OH (US); Michael E. Moran, Marysville, OH (US)

Correspondence Address: Intellectual Property;Honeywell International Inc., 101 Columbia Rd., P.O. Box 2245, Morristown, NJ, 07962, US

(73) Assignee: Honeywell International Inc.

(21) Appl. No.: 11/897,114

(22) Filed: Aug. 29, 2007

(51) Int. Cl. B23K 20/10

(52) U.S. Cl. 228/110.1; 228/1.1

(57) ABSTRACT

An automatic chamber evacuating method, system, and apparatus are disclosed, which include a nest, wherein a region or chamber, such as for example the reference chamber of an absolute pressure sensor, may be placed. A switch is used to initiate an automatic process whereby an air operated chuck seals to a tubular region protruding from the chamber via compressed air. An evacuating device connected to the tubular region by the chuck then applies a vacuum which evacuates the chamber. When the chamber has been sufficiently evacuated a message is sent to a programmable logic controller which then outputs a signal to an ultrasonic welding apparatus. The ultrasonic welder crimps and seals the tubular region thereby quickly and efficiently creating a permanent vacuum in the chamber.

### TECHNICAL FIELD

Embodiments are generally related to sensor devices, methods and systems. Embodiments are also related to absolute pressure sensor devices and systems, a method for the evacuation and sealing thereof, and a manufacturing method therefor. Additionally, embodiments relate to the automation of that manufacturing method.

### BACKGROUND OF THE INVENTION

Absolute pressure sensors measure pressure relative to a perfect vacuum, as opposed to gauge or differential pressure sensors which measure pressure relative to atmospheric pressure or the difference between two input pressures respectively. Absolute pressure sensors usually have an evacuated reference chamber. Therefore, absolute pressure sensors require that a vacuum chamber be sealed on the reference side of a sensing diaphragm. Common techniques to seal such chambers are usually complicated and messy, requiring a skilled operator. Such techniques require pulling a vacuum through an opening or tube in the chamber and then sealing it to preserve the vacuum.

Sealing the chamber may be accomplished in various ways. The tube may be crimped and soldered closed, a plug may be welded into the opening, or an adhesive may be used to plug or cover the opening. Prior art has also disclosed methods such as formfitting a plug through heat expansion. These sealing techniques are complicated and labor intensive.

One of the problems with conventional methods for constructing the evacuated chamber of an absolute pressure sensor is the amount of time and labor required. The embodiments disclosed herein address this problem by providing a process by which the previously labor intensive steps of evacuating and sealing the chamber are automated. Further the embodiments disclosed herein allow for such automation by developing a simple, efficient means for sealing the chamber using an ultrasonic welding apparatus.

### BRIEF SUMMARY OF THE INVENTION

The following summary of the invention is provided to facilitate an understanding of some of the innovative features unique to the present invention and is not intended to be a full description. A full appreciation of the various aspects of the invention can be gained by taking the entire specification, claims, drawings, and abstract as a whole.

It is, therefore, one aspect of the present invention to provide an improved chamber evacuating and sealing method, system, and apparatus.

It is another aspect of the present invention to provide an improved method, system, and apparatus for evacuating and sealing reference chambers in absolute pressure sensors.

The aforementioned aspects of the invention and other objectives and advantages can now be achieved as described herein. An automatic region evacuating method, system, and apparatus are disclosed herein. A region or chamber, such as, for example, the reference chamber of an absolute pressure sensor, is placed in a nest. A switch is then used to initiate an automatic process whereby an air operated chuck seals, via compressed air, to a tubular region protruding from the chamber. An evacuating device connected to the tubular region by the air operated chuck then evacuates the chamber. When the chamber has been sufficiently evacuated to a predetermined user-defined level as measured by a vacuum gauge, a message is sent to a programmable logic controller which then outputs a signal to an ultrasonic welding apparatus. The ultrasonic welder crimps and seals the tubular region creating a permanent vacuum in the chamber.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a schematic of an automated method for evacuating and sealing a chamber, such as an absolute pressure sensor reference tube, which can be implemented in accordance with one embodiment of the present invention.

FIG. 2 illustrates a high level flow chart explaining the steps followed in an automated process to evacuate and seal a chamber, such as an absolute pressure sensor reference chamber, in accordance with one embodiment of the present invention.

FIG. 3 illustrates a side perspective of a reference chamber of a pressure sensor in accordance with a preferred embodiment of the present invention.

FIG. 4 illustrates an exploded view of the chuck to chamber connection, via the tubular region, in accordance with a preferred embodiment of the present invention.

### DETAILED DESCRIPTION OF THE INVENTION

The particular values and configurations discussed in these non-limiting examples can be varied and are cited merely to illustrate at least one embodiment of the present invention and are not intended to limit the scope of the invention.

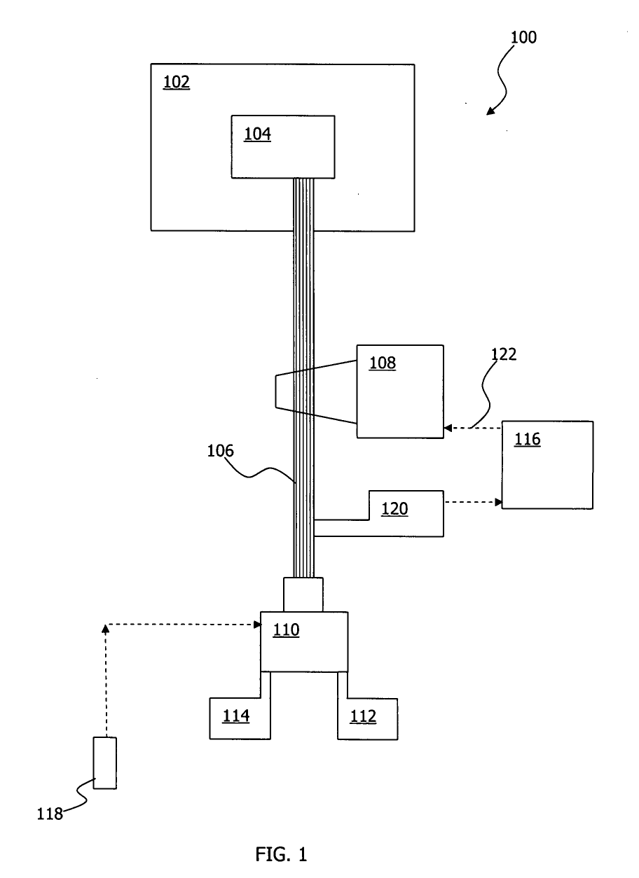

FIG. 1 illustrates a schematic diagram of an automated evacuating and sealing apparatus 100, which can be implemented in accordance with one embodiment of the present invention. Evacuating and sealing apparatus 100 generally includes a nest 102 which is constructed to hold the region to be evacuated (chamber) 104 in place during the automated process. An ultrasonic welding apparatus 108 is positioned to operate on the tubular region 106 after the chamber 104 has been evacuated.

Ultrasonic welding is a technique that can be used to hermetically bind objects together. High frequency vibrations cause local melting of the material, usually plastic, to be welded together. In accordance with a preferred embodiment of the invention, ultrasonic welding apparatus 108 requires no connective pieces, soldering material, or adhesive, making it much easier to introduce in an automated system. Further, use of an ultrasonic welding apparatus represents a unique innovative feature of the present invention.

Historically, materials which could be welded by ultrasonic means were limited to those which were highly acoustically conductive and had a low melting point. Modern, commercially available, ultrasonic welding apparatuses are significantly more powerful. This has resulted in a much larger array of materials to which ultrasonic welding may be applied. Even so, the type of material used for tubular region 106 is still a consideration. In a preferred embodiment tubular region 106 is made of copper or any other material that can be ultrasonically welded.

FIG. 1 further illustrates an air operated chuck 110, with associated vacuum source 112 and compressed air 114, sealed to the tubular region 106 using compressed air after the chamber 104 has been placed in the nest 102 and the operator has turned on switch 118.

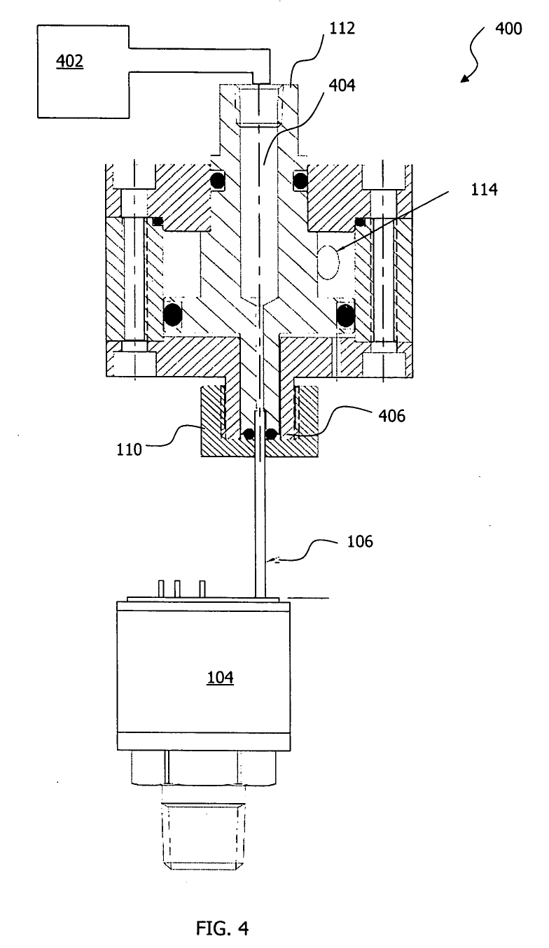

FIG. 4. illustrates an expanded view of the chuck to chamber assembly 400. The tubular region 106 is inserted into the chuck 110. This can be implemented in accordance with one embodiment of the present invention. As FIG. 4 illustrates, pneumatic pressure is applied to the port in the side of the chuck's reservoir compressing o-ring 406 sealing chuck 110 to the tubular region 106. Also, there is a large vacuum reservoir 402 connected to the vacuum 112 side of the chuck. Vacuum is introduced through the port on the back of the piston 404. This provides a constant, large volume of vacuum and allows for rapid evacuation of the chamber during operation of the evacuating and sealing apparatus 100.

As illustrated in FIG. 1, the chamber 104 is then evacuated to a predetermined user-defined level, measured by vacuum gauge 120. Vacuum gauges of all kinds are readily available on the market today. Any such vacuum gauge will suffice as long as it is capable of measuring absolute pressures at or near perfect vacuum. After sufficient evacuation is achieved, programmable logic controller (PLC) 116 controls the ultrasonic welder 108 which crimps and seals tubular region 106, thus creating a permanent vacuum in chamber 104.

Programmable logic controllers are digital computers used for automation of industrial processes. Generally, PLCs are designed to be more durable and can handle more input and output arrangements than typical personal computers. Common inputs include readings from sensors and actuators. Thus, it would be appreciated by one skilled in the art that PLC 116 is well suited to receive information from vacuum gauge 120 and, based on that information, output control signals to ultrasonic welding apparatus 108.

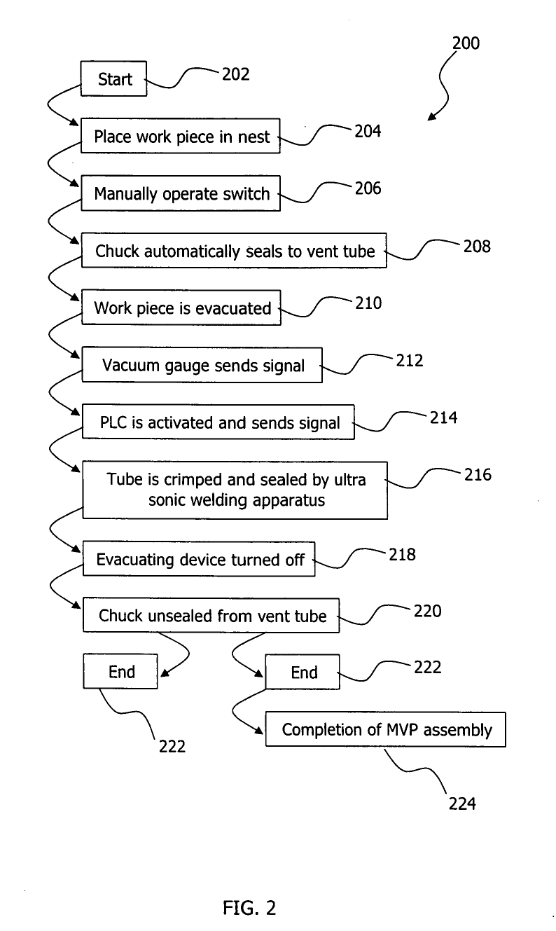

FIG. 2 illustrates a flow chart 200 depicting the process by which a chamber is evacuated and sealed in accordance with one embodiment of the present invention.

The process depicted in FIG. 2 can be initiated, as indicated, at block 202. As illustrated next, at block 204, the region or chamber to be evacuated 104, for example the reference chamber of an absolute pressure sensor, is placed in a nest 102. Next, the operator actuates a switch, as indicated at block 206, to begin the automated process. The chuck 110 now automatically seals to tubular region 106, depicted by block 208. This seal is affected by the application of compressed air 114. At this point the actual evacuation of the region 104 takes place as shown by block 210. This flow chart does not include a time scale for these processes. However, in a preferred embodiment the steps of blocks 206 to 220 occur in a relatively short amount of time. This may be attributed, generally, to the automation of all of these steps and specifically to the large vacuum reservoir 402 used in the evacuation process indicated by block 210.

Block 212 indicates as the vacuum is being drawn, a vacuum gauge 120 is measuring the vacuum inside the region 104. When a preset user-defined vacuum level has been reached, a signal is sent to a programmable logic controller (PLC) 116. Block 214 indicates the PLC 116 receives this input and outputs a control signal 122 to the ultrasonic welding apparatus 108. The ultrasonic welding apparatus 108 then crimps and seals the tubular region 106 thereby creating a permanent vacuum in the region 104. This step is indicated by block 216. This is another specific feature of one preferred embodiment of the present invention which makes the entire process relatively fast. Prior sealing methods of evacuated chambers required skilled workers to perform complicated and cumbersome procedures to correctly seal the evacuated region 104. However, as presented, the ultrasonic welding tool automatically crimps and seals the tubular region neatly and efficiently without the need for any trained operator's expertise.

The evacuating device is then turned off 218 and the chuck 110 is unsealed from the tubular region 106 as indicated by block 220. At this point the automated process has ended as indicated by block 222. However, alternatively, in the case that the region being evacuated 104 is a reference chamber to an absolute pressure sensor 300, completion of the assembly of that sensor will follow the end 222 of this process as indicated by block 224.

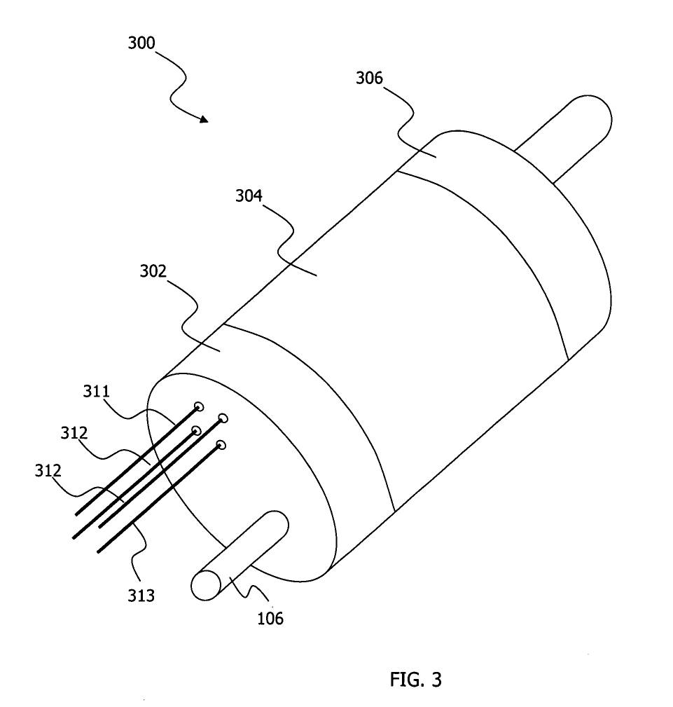

FIG. 3 illustrates a side perspective view of an absolute pressure sensor reference chamber 300, which can be implemented in accordance with one embodiment of the present invention. One skilled in the art would appreciate absolute pressure sensor reference chamber 300 is one type of chamber that might be used as the region to be evacuated 104 and sealed in FIG. 1. The description and illustration of this chamber are intended only as an example of one embodiment of the invention. The same automated process, including the use of an ultrasonic welding apparatus to seal tubular region 106, can be applied to the evacuation and sealing of any chamber with an associated tube.

Absolute reference chamber 300 generally includes a glass sealed header 302 welded to can 304 which in turn is welded to port assembly 306. Tubular region 106 (also referred to as a vent tube) serves as a vehicle for evacuating reference chamber 300. A plurality of wires 310 a-d are welded to the glass sealed header 302.

This embodiment is intended to display a preferred method for crimping and sealing reference chamber 300 after it has been evacuated. Once reference chamber 300 has been evacuated a commercially available ultrasonic welder is used to crimp and hermetically seal tubular region 106 in accordance with a preferred embodiment as described by flow chart 200.

1. An evacuating and sealing method, comprising:
automatically connecting a chuck to a tubular structure having a tube formed therein, wherein said chuck is connected to an evacuating device that evacuates a region to a predetermined, user-defined level; and
automatically crimping and sealing said tubular structure with an ultrasonic welding apparatus to thereby create a sealed evacuated region from said region.

2. The method of claim 1 further comprising configuring said chuck to be air operated and sealing said chuck to said tubular structure via compressed air.

3. The method of claim 1 further comprising configuring said evacuating device to connect to said tubular structure via said chuck.

4. The method of claim 1 further comprising forming said tubular structure from a material that is sealable by an ultrasonic welding apparatus.

5. The method of claim 1 further comprising measuring said predetermined, user-defined level of evacuation using a vacuum gauge.

6. The method of claim 1 further comprising initiating said evacuating and sealing method by actuating a switch.

7. The method of claim 1 further comprising controlling input and output signals with a programmable logic controller (PLC).

8. The method of claim 1 further comprising manufacturing an absolute pressure sensor, wherein said evacuated region is a reference chamber of said absolute pressure sensor.

9. A system, comprising:
a chuck adapted to automatically connect to a tubular structure having a tube formed therein, wherein said chuck is further connected to an evacuating device that evacuates a region to a predetermined, user-defined level;
an ultrasonic welding apparatus which automatically crimps and seals said tubular structure thereby creating a sealed evacuated region from said region.

10. The system of claim 9 wherein said chuck further comprises an air operated chuck that seals to said tubular structure via compressed air.

11. The system of claim 9 wherein said chuck further comprises a chuck connected to an evacuating device such that said evacuating device is connected to said tubular region via said chuck.

12. The system of claim 9 wherein said tubular region is comprised of a material, weldable by said ultrasonic welding apparatus.

13. The System of claim 9 wherein said predetermined user-defined vacuum is measured using a vacuum gauge apparatus

14. The system of claim 13 wherein said vacuum gauge and said ultrasonic welding apparatus are controlled by a programmable logic controller (PLC).

15. The system of claim 9 wherein said region consists of a reference chamber of an absolute pressure sensor.

16. An evacuating and sealing apparatus comprising:
a nest for holding a region to be evacuated and sealed;
a chuck, wherein said chuck is connected to an evacuating apparatus and is located such that a tubular region protruding from said region to be evacuated and sealed is accessible by said chuck thereby allowing said evacuating apparatus to evacuate said region to be evacuated and sealed;
a vacuum gauge for measuring the vacuum within said region to be evacuated;
an ultrasonic welding apparatus located such that it can automatically crimp and seal said tubular region thereby creating a permanent vacuum within said region to be evacuated; and
a programmable logic controller (PLC) to receive input and output signals and automatically control the operations of said vacuum gauge and said ultrasonic welding apparatus.

17. The apparatus of claim 16 wherein said chuck is air operated and seals to said tubular structure via compressed air.

18. The apparatus of claim 16 wherein said evacuating device is connected to a large vacuum reservoir, thereby allowing quick evacuation of said region to be evacuated and sealed.

19. The apparatus of claim 16 further comprising a switch used to initiate an automatic evacuation and sealing of said region to be evacuated and sealed.

20. The apparatus of claim 16 wherein said region to be evacuated and sealed comprises an absolute pressure sensor, wherein said evacuated region is a reference chamber of said absolute pressure sensor.
